(19) United States
(12) Patent Application Publication
(10) Pub. No.: US 2008/0055633 A1
(43) Pub. Date: Mar. 6, 2008

(54) Computer readable medium, computer data signal, instruction apparatus, image processing method and image processing system

(75) Inventors: Hajime Kajiyama, Kanagawa (JP); Shigeki Muramatsu, Kanagawa (JP); Takahide Sasamori, Kanagawa (JP); Yuji Hikawa, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/729,905

(22) Filed: Mar. 30, 2007

(30) Foreign Application Priority Data
Aug. 31, 2006 (JP) P2006-235421

(51) Int. Cl. G06F 3/12; G06F 17/00

(52) U.S. Cl. 358/1.15; 715/273; 358/1.1

(57) ABSTRACT

A computer readable medium stores a program causing a computer to execute a process for creating a job. The process includes: accepting document data created by application software; converting the document data into image processing data in a format which is interpretable when image processing is executed for the document data; determining as to whether or not at least one of the document data and the image processing data contains predetermined information; and when it is determined that the at least one of the document data and the image processing data contains the predetermined information, outputting a job indicating (i) executing the image processing for the image processing data and (ii) creating an image of an execution history of the image processing.

### CROSS-REFERENCE TO RELATED APPLICATIONS

This application is based on and claims priority under 35 U.S.C. §119 from Japanese Patent Application No. 2006-235421 filed Aug. 31, 2006.

### BACKGROUND

### Technical Field

This invention relates to a computer readable medium, a computer data signal, an instruction apparatus, an image processing method and an image processing system.

### SUMMARY

According to an aspect of the invention, a computer readable medium stores a program causing a computer to execute a process for creating a job. The process includes: accepting document data created by application software; converting the document data into image processing data in a format which is interpretable when image processing is executed for the document data; determining as to whether or not at least one of the document data and the image processing data contains predetermined information; and when it is determined that the at least one of the document data and the image processing data contains the predetermined information, outputting a job indicating (i) executing the image processing for the image processing data and (ii) creating an image of an execution history of the image processing.

### BRIEF DESCRIPTION OF THE DRAWINGS

Exemplary embodiments of the invention will be described in detail below with reference to the accompanying drawings, wherein:

FIG. 1 is a drawing to show an image processing system according to a first exemplary embodiment of the invention;

FIG. 2 is a block diagram to show the main configuration of the image processing system according to the first exemplary embodiment of the invention;

FIG. 3 is a drawing to show an example of a search target setting screen;

FIG. 4 is a drawing to show an example of a registration window;

FIG. 5 is a drawing to show an example of an edit window;

FIG. 6 is a drawing to show an example of a warning window;

FIG. 7 is a drawing to show the data structure of a job file;

FIG. 8 is a flowchart to show the operation of the image processing system according to the first exemplary embodiment of the invention;

FIG. 9 is a drawing to show a search target setting screen in a client according to a second exemplary embodiment of the invention;

FIG. 10 is a drawing to show an example of a registration window;

FIG. 11 is a drawing to show a data string of an electronic watermark in a PDL description section;

FIG. 12 is a drawing to show an example of a registration window in a client according to a third exemplary embodiment of the invention; and

FIG. 13 is a drawing to show an example of a search target setting screen in a client according to a fourth exemplary embodiment of the invention.

### DETAILED DESCRIPTION

### First Exemplary Embodiment

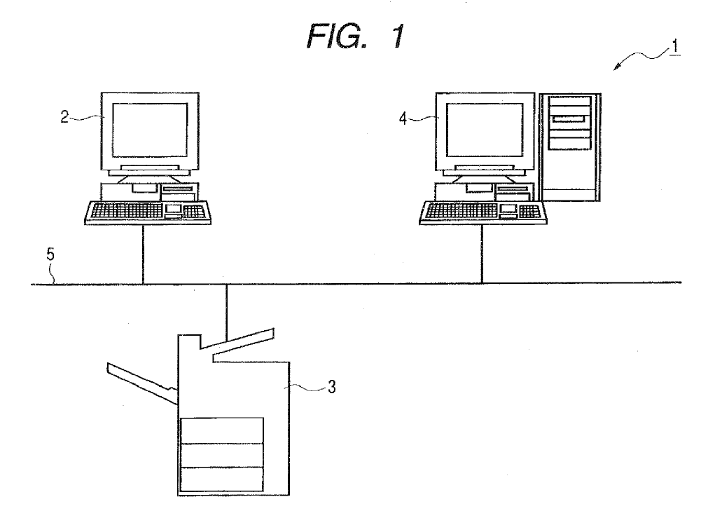

FIG. 1 shows an image processing system 1 according to a first exemplary embodiment of the invention. The image processing system 1 includes a client 2 as a instruction apparatus for accepting an image processing command (which will be hereinafter referred to as “job”), a multifunction processing machine 3 as a processing apparatus for executing the job and generating an image of an execution history (which will be hereinafter referred to as “image log”), a log server 4 as a management apparatus for storing the generated image log, and a network 5 such as a LAN (local area network) or the Internet for connecting the client 2, the multifunction processing machine 3, and the log server 4. Although FIG. 1 shows one client 2 and one multifunction processing machine 3, plural clients 2 and/or plural processing machines 3 may be provided.

The “image” contains an image made up of a document, a pattern and a photo or a table, an image of mixture of those, an image of text information or image information superposed on an original image, etc.

The “job” is a process or a process group to be executed by a computer; here the “job” also contains a job that is a process for executing a function such as a copying process, a printing process, a scanning process, a fax transmission/reception process, a job flow in which plural jobs are executed consecutively or concurrently, image edit (combining, processing), etc.

The “processing apparatus” contains a copier, a printer, a scanner, a facsimile, etc., as well as the multifunction processing machine mentioned above. The multifunction processing machine refers to a machine having plural functions such as a copying function, a printing function, a scanning function, and a fax transmission/reception function. The “processing apparatus” is made up of not only a single unit, but also may be made up of plural units corresponding to the plural functions.

The “image log” is an execution record image created as a jog execution record and is an image created by job processing before, during, or after execution of the job or is an image created in association with the job processing. For example, used as the “image log” may be an image provided by reducing the number of pixels of the image handled in the job, an image into which a color image is converted so as to have a smaller number of colors or so as to have a gray scale, one or more images selected from among images or all images handled in the job.

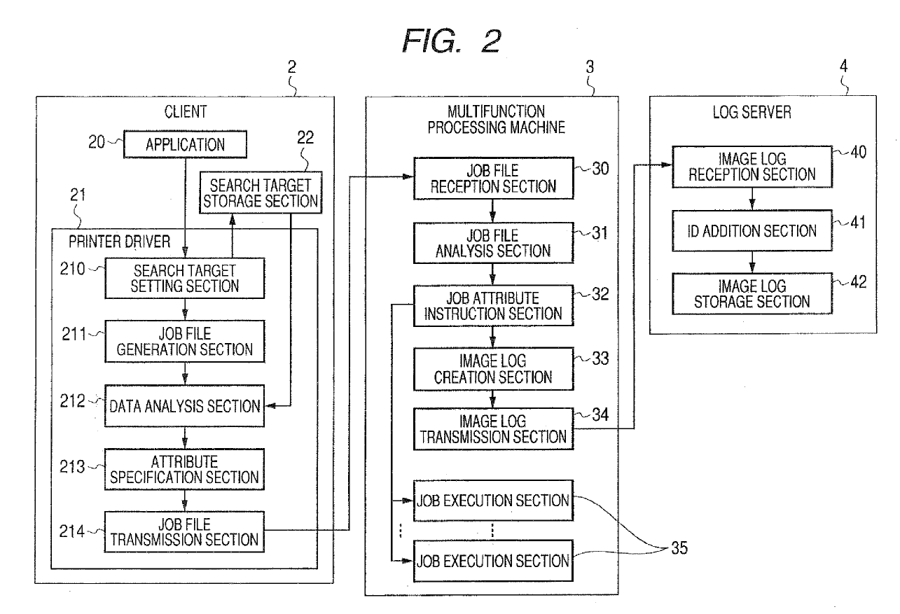

FIG. 2 is a block diagram to show the main configuration of the image processing system 1.

### (Client)

The client 2 has application software 20 that is a program, such as a document preparation program, for causing a computer to execute a process of creating, editing and storing document data, a printer driver 21 that is software for outputting information for controlling a job execution section of the printing function of the multifunction processing machine 3, and a search target storage section 22 for storing the search target as setting of an instruction for creating an image log. The printer driver 21 implements an image processing program.

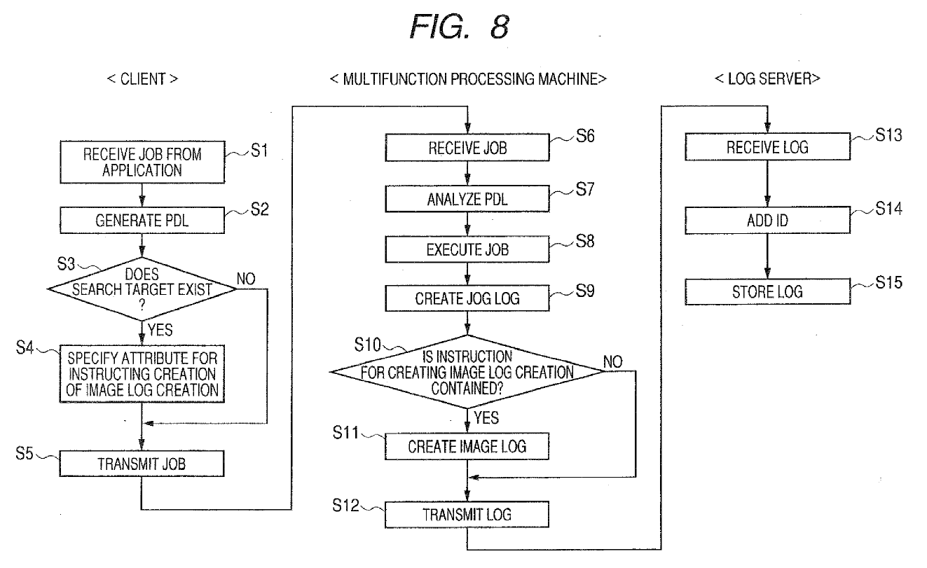

The client 2 can be implemented, for example, as an apparatus such as a personal computer having a communication section connected to the network 5, a CPU, a storage section made up of ROM, RAM, an HDD, etc., for storing programs as shown in FIG. 8 containing the application software 20 and the printer driver 21 and various pieces of data of search targets, etc., an input section including a keyboard, a mouse, etc., and a display section such as an LCD (Liquid Crystal Display) for displaying a setting screen, etc.

The printer driver 21 converts document data that is created in the application software 20 and that is instructed to be printed, into a page description language (abbreviated as “PDL”) for generating data (image data) to be recognized and output by the print job execution section of the multifunction processing machine 3. The printer driver 21 also converts a instruction attribute of instruction information concerning printing instructed by the application software 20 or the printer driver 21 into a printer job language (abbreviated as “PJL”).

The printer driver 21 includes a search target setting section 210 for setting a search target, a job file generation section 211 for generating job files in the PDL and the PJL, a data analysis section 212, which may serve as a determining unit, for analyzing the PDL and determining as to whether or not a search target is included, namely, whether or not an image log is to be created, an attribute specification section 213, which may serve as an attribute addition unit, for adding to the job file an attribute for instructing creation of an image log for instructing creation of an image log as a job attribute of a printing process when a search target is included, and a job file transmission section 214 for transmitting the job file to the multifunction processing machine 3.

### (Multifunction Processing Machine)

The multifunction processing machine 3 includes a job file reception section 30 for receiving the job file from the client 2, a job file analysis section 31 for analyzing the instruction attribute of the job, a job attribute instruction section 32 for receiving the instruction attribute of the job from the job file analysis section 31 and if an instruction for creating an image log an image log is given, sending the command to job execution sections 35, an image log creation section 33 for creating an image log file containing attribute information (for example, job log) that are various pieces of information concerning an image log and job processing, an image log transmission section 34, which may serve as a transfer unit, for transferring the created image log file to the log server 4, and plural job execution sections 35 for executing jobs.

The job file analysis section 31, the job attribute instruction section 32, and the image log creation section 33 of the multifunction processing machine 3 can be implemented not only as hardware, but also as a CPU and a storage section of ROM, RAM, an HDD, etc., for storing programs, data, etc., as shown in FIG. 8, and the like.

The job log may include a job ID that is information for identifying a processing job, a job type that is a type of a processing function in the job, a user, a use time, a number of copies, a job status and a result of the job processing, for example. The job execution sections 35 are provided in a one-to-one correspondence with the functions of copying, printing, scanning and fax.

### (Log Server)

The log server 4 includes an image log reception section 40 for receiving the image log file containing the image log and the jog log sent from the multifunction processing machine 3, an ID addition section 41 for adding an image log creator ID (identification information), for example, an ID generated for each multifunction processing machine 3 to the image log file, and an image log storage section 42 for storing the image log file and the ID.

The log server 4 can be implemented, for example, as an apparatus such as a host computer having a communication section connected to the network 5, a CPU, a storage section made up of ROM, RAM, an HDD, etc., for storing programs and data as shown in FIG. 8, an input section including a keyboard, a mouse, etc., and a display section for displaying a setting screen, etc.

### (Operation of Image Processing System)

Next, the operation of the image processing system 1 according to the first exemplary embodiment will be described with reference to FIGS. 1 to 7 and according to a flowchart of FIG. 8.

### (1) Setting of Search Target

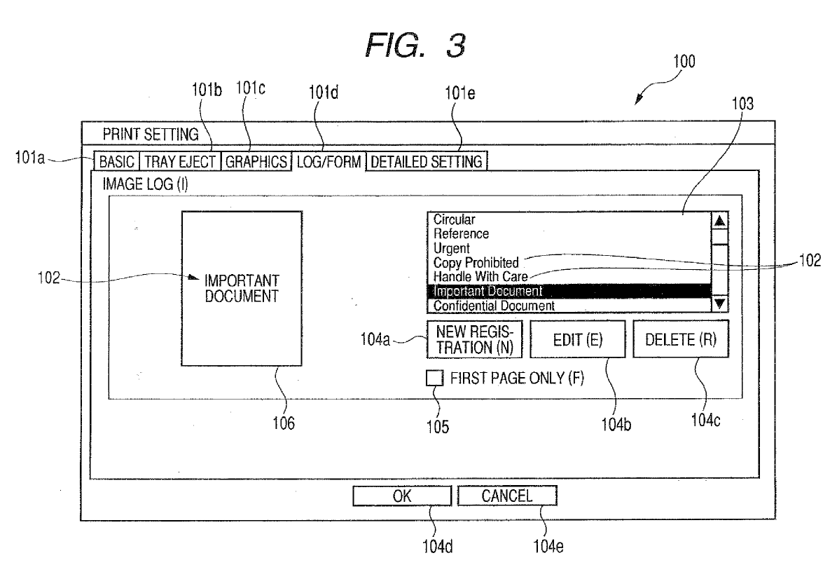

FIG. 3 shows an example of a search target setting screen. When a user operates the input section of the client 2, the search target setting section 210 displays a search target setting screen 100 shown in FIG. 3 on the display section of the client 2. The search target setting screen 100 allows the user to set a search target, which is used in setting the instruction for creating the image log. The search target setting screen 100 includes tabs 101a to 101e, that is “BASIC,” “TRAY/EJECT,” “GRAPHICS,” “LOG/FORM,” and “DETAILED SETTING.” The search target setting screen 100 also includes a listing window 103 for listing character strings (text information) 102 of the registered search target on the right side of the LOG/FORM tab 101d. The search target setting screen 100 also includes a “NEW REGISTRATION” button 104a, an “EDIT” button 104b, a “DELETE” button 104c, and a “FIRST PAGE ONLY” check box 105 below the listing window 103. A document image 106 containing the character string 102 specified in the listing window 103 is displayed on the left side of the listing window 103.

The “NEW REGISTRATION” button 104a is used to register a new character string 102, the “EDIT” button” 104b is used to edit any registered character string 102, and the “DELETE” button 104c is used to delete any registered character string 102.

If the user checks the “FIRST PAGE ONLY” check box 105, only the first page of a document, which is instructed to be printed, is searched for a character string matching the setup character string 102.

Numeral 104d denotes an “OK” button for confirming the settings made on the setting screen 100 and numeral 104e denotes a “CANCEL” button for canceling the settings.

For example, “Circular,” “Reference,” “Urgent,” “Copy Prohibited,” “Handle With Care,” “Important Document,” “Confidential Document,” and the like are listed on the listing window 103 as the registered character strings. “Secret,” “Nickname,” “Contract,” and the like are also listed although they are not shown in the figure. Further, “(None)” is displayed on the top of the listing and the user specifies “(None)” if he or she does not specify any character string 102. For example, if the user selects the “Important Document” character string 102 from among the listed character strings 102, the selected character string is reverse-displayed on the listing window 103 as shown in FIG. 3 and if the user selects the “OK” button 104d, the search target setting section 210 stores the “Important Document” character string 102 in the search target storage section 22 as the search target.

(a) New Registration

If the user selects the “NEW REGISTRATION” button 104a, a registration window 110 is displayed on the display section, allowing the user to register a new search target character string 102.

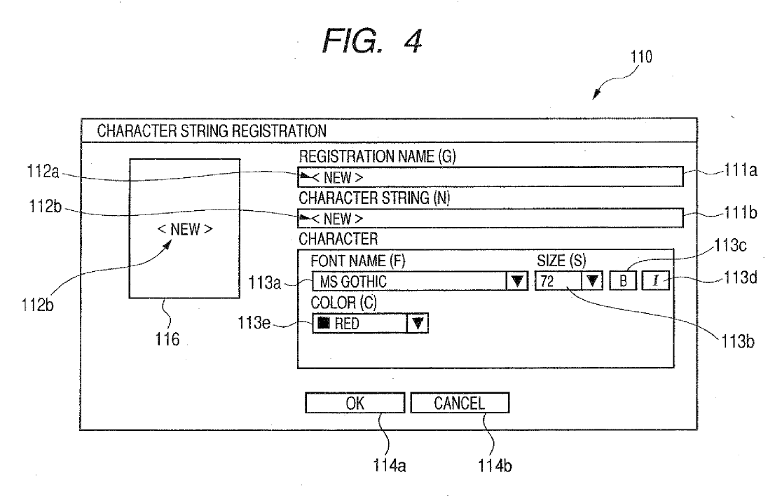

FIG. 4 shows an example of the registration window 110. Displayed in the right portion of the registration window 110 are a registration name input field 111a for entering a registration name 112a, a character string input field 111b for entering a search target character string 112b, which is used in setting an instruction for creating an image log, and character attribute selection fields 113a to 113e for selecting character font name, size, bold, italic, and color respectively. A document image 116 is displayed in the left portion of the registration window 110.

Numeral 114a denotes an “OK” button for confirming the registration and numeral 114b denotes a “CANCEL” button for canceling the registration. The registration window 110 may be provided with no character attribute selection fields 113a to 113e.

If the user operates the mouse of the input section of the client 2 for moving a cursor to the input fields 111a and 111b and operates the keyboard of the input section for entering a registration name 112a in the registration name input field 111a and a character string 112b in the character string input field 111b and then selects the “OK” button 114a, the character string 112b is newly registered and is displayed on the listing window 103.

(b) Editing of Search Target

If the user selects the “EDIT” button 104b on the setting screen 100 shown in FIG. 3, an edit window 120 is displayed on the display section of the client 2, allowing the user to edit a character string 102.

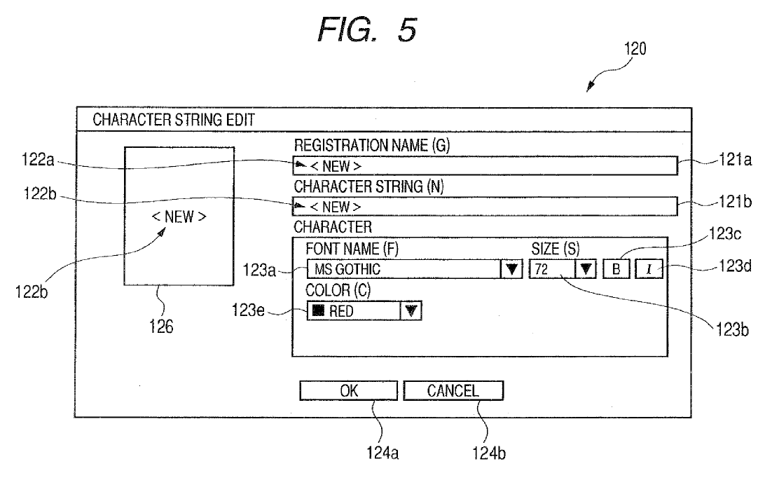

FIG. 5 shows an example of the edit window 120 having a function of editing a once registered character string 102. A registration name input field 121a, a character string input field 121b, and character attribute selection fields 123a to 123e for selecting character font name, size, bold, italic, and color respectively are displayed on the edit window 120 like the registration window 110 shown in FIG. 4. A document image 126 containing a character string 122b entered in the character string input field 121b is displayed on the left portion of the edit window 120.

If the user selects the character string 102 to be edited out of the listing on the listing window 103 of the setting screen 100 shown in FIG. 3 and selects the “EDIT” button 104b, the edit window 120 shown in FIG. 5 is displayed and the character string 122b to be edited is displayed in the character string input field 121b. If the user operates the keyboard of the input section for editing the character string 122b in the character string input field 121b and selects the “OK” button 124a, the post-edited character string 102 is registered and the post-edited character string 122b is displayed on the listing window 103 shown in FIG. 3.

(c) Deletion of Character String

To delete any registered character string, if the user selects the character string 102 to be deleted out of the listing on the listing window 103 of the setting screen 100 shown in FIG. 3 and selects the “DELETE” button 104c on the setting screen 100 shown in FIG. 3, a warning window 130 is displayed on the display section of the client 2, allowing the user to delete the setup character string.

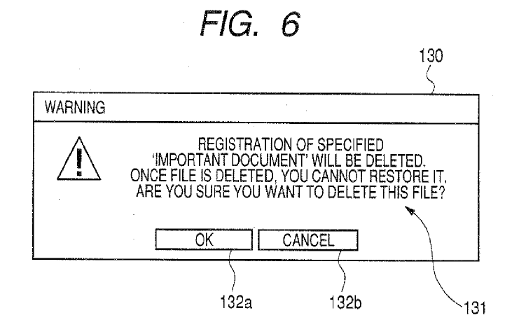

FIG. 6 shows an example of the warning window. It shows the case where “Important Document” is to be deleted. A warning message 131 such that “REGISTRATION OF SPECIFIED ‘IMPORTANT DOCUMENT’ WILL BE DELETED. ONCE FILE IS DELETED, YOU CANNOT RESTORE IT. ARE YOU SURE YOU WANT TO DELETE THIS FILE?” is displayed on the warning window 130. If the user presses an “OK” button 132a, the character string 102 is deleted. If the user presses a “CANCEL” button 132b, the deletion command is canceled.

### (2) Data Analysis

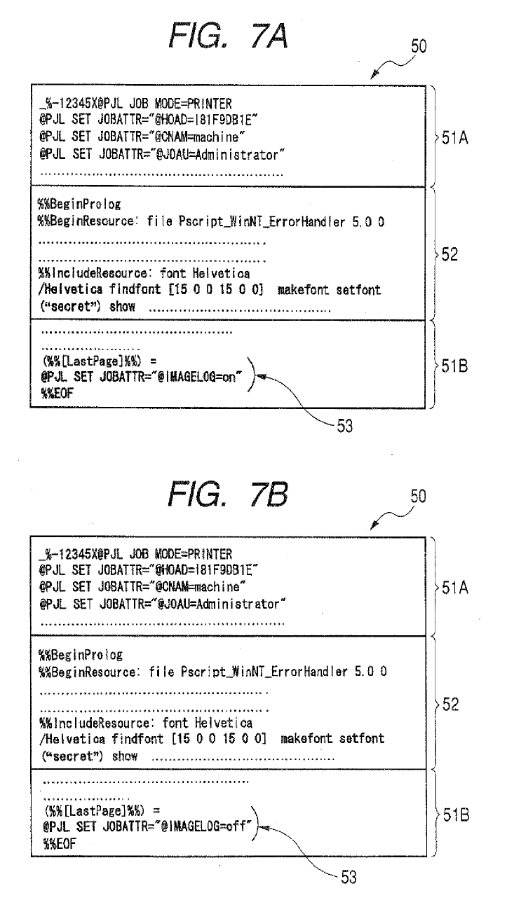

FIGS. 7A and 7B show the data structure of a job file 50 generated by the job file generation section 211. The following processing flow will be described with the assumption that the search target is set through the search target setting section 210 so that the character string 102 is “secret,” the font name is Helvetica and the font size is 15 points and with the assumption that such a search target is stored in the search target storage section 22. For PDL data, PostScript (trademark of Adobe Systems Incorporated) language is used by way of example. However, any other language such as Interpress (trademark of Xerox Corporation) may be used.

Upon reception of document data which is instructed to be printed from the application software 20 (S1), the job file generation section 211 of the printer driver 21 generates a job file 50. That is, the job file generation section 211 generates a PDL description portion 52 representing the document data in the PDL and generates first and second PJL description portions 51A and 51B in the PJL based on the instruction attribute of the job.

Next, the data analysis section 212 analyzes the PDL description portion 52 (S2) and analyzes as to whether or not the PDL description portion 52 contains the search target stored in the search target storage section 22 (S3). In the example shown in FIG. 7, the information “/Helvetica findfont [15 0 0 15 0 0] makefont setfont (“secret”) show” described in the PDL description portion 52 contains information “character string 102: “secret”, “font name: Helvetica,” “font size: 15 points” of the search target stored in the search target storage section 22 (YES at S3). Therefore, the data analysis section 212 notifies to the attribute specification section 213 that the search target is included. At step S3, if the PDL description portion 52 is described in character strings, whether or not the character strings match the character strings of the search target stored in the search target storage section 22 may be analyzed. Alternatively, if the description of the PDL description portion 52 is coded by a predetermined coding system, the PDL description portion 52 may be decoded into character strings and then whether or not the character strings match the character strings of the search target stored in the search target storage section 22 may be analyzed. Further, the data analysis section 212 may analyze the document data received from the application software 20 rather than the information described in the PDL description portion 52 and may analyze as to whether or not the document data contains the search target stored in the search target storage section 22.

Upon reception of the notification that the search target is included from the data analysis section 212, the attribute specification section 213 adds “@PJL SET JOBATTR=“@IMAGELOG=on”” which is a description of an attribute 53 indicating an instruction for creating an image log to the second PJL description portion 51B as shown in FIG. 7A (S4). If the PDL description portion 52 does not include the search target (NO at S3), no attribute for instructing creation of an image log is added. Alternatively, the attribute specification section 213 may add “@PJL SET JOBATTR=“@IMAGELOG=off”” which is a description indicating of an attribute 53 indicating an instruction for prohibiting creation of an image log, to the second PJL description portion 51B as shown in FIG. 7B.

The job file transmission section 214 transmits the job file 50 to the multifunction processing machine 3 through the network 5 (S5).

### (3) Job Execution

When the job file reception section 30 of the multifunction processing machine 3 receives the job file 50 from the client 2 (S6), the job file analysis section 31 analyzes the instruction attribute described in the first and second PJL description portions 51A and 51B in the job file 50 sent from the client 2 (S7). The job attribute instruction section 32 receives the instruction attribute concerning a job processing request from the job file analysis section 31 and requests the job execution section 35 to perform job processing. The corresponding job execution section 35 executes the job (S8). The image log creation section 33 creates a job log (S9). Further, the image log creation section 33 determines as to whether or not the instruction attribute contains an attribute for instructing creation of an image log (S10). If an attribute for instructing creation of an image log is contained (YES at S10), the image log creation section 33 creates an image log from the job file 50 as well as normal print job processing and creates an image log file including the image log and the job log (S11). The image log transmission section 34 transfers the created image log file to the log server 4 through the network 5 (S12).

### (4) Job Management

When the image log reception section 40 of the log server 40 receives the image log file sent from the multifunction processing machine 3 (S13), the ID addition section 41 adds ID (identification information), for example, ID generated for each multifunction processing machine 3 to the image log file (S14), and stores the image log file with the ID in the image log storage section 42 (S15).

### Second Exemplary Embodiment

Next, a second exemplary embodiment of the invention will be described. While In the first exemplary embodiment, a character string is a search target which is used in setting an instruction for creating an image log, in the second exemplary embodiment, electronic watermark image information (or text information) can be set as a search target. The others portions of the second exemplary embodiment are similar to those of the first exemplary embodiment.

### (Operation of Image Processing System)

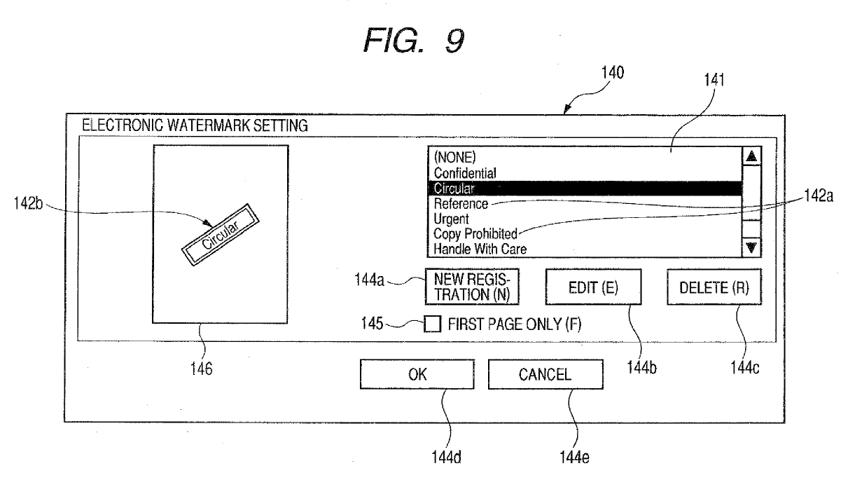

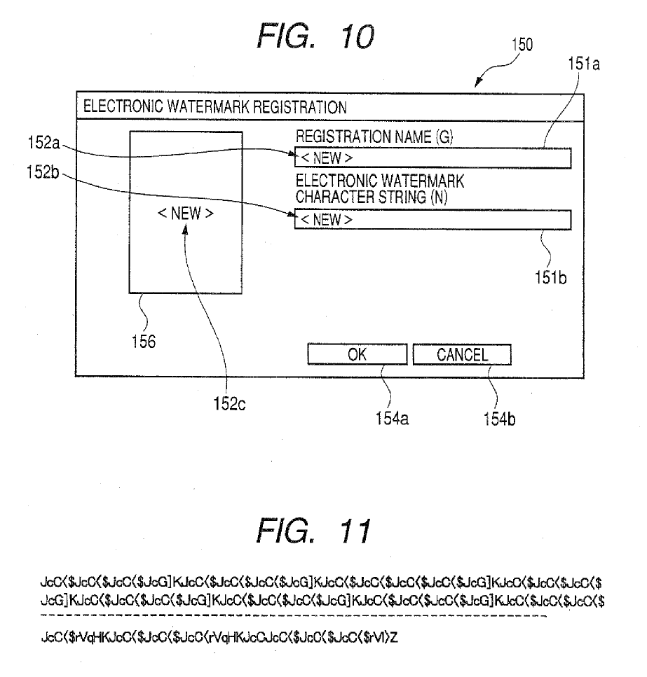

Next, the operation of an image processing system 1 according to the second exemplary embodiment will be described with reference to FIGS. 9 and 10.

### (1) Setting of Search Target

FIG. 9 shows a search target setting screen 140 in a client 2 according to the second exemplary embodiment of the invention. A listing window 141 for listing registered electronic watermark character strings 102 is provided in the right portion of the search target setting screen 140. A “NEW REGISTRATION” button 144a, an “EDIT” button 144b, a “DELETE” button 144c, an “OK” button 144d, and a “CANCEL” button 144e are provided below the listing window 141. A document image 146 having an electronic watermark 142b is displayed in the left portion of the listing window 141.

The “electronic watermark” refers to both of (a) electronic watermark image information embedded in image data and includes a visible electronic watermark in a recognizable form like a log and (b) an invisible electronic watermark which is unrecognizable to human's eyes but can provide information such as a creator when it is read by dedicated electronic watermark detection software.

The “NEW REGISTRATION” button 144a is used to register a new electronic watermark character string 142a, the “EDIT” button 144b is used to edit any registered character string 142a, and the “DELETE” button 144c is used to delete any registered character string 142a.

If the user checks a “FIRST PAGE ONLY” check box 145, only the first page of the document data is searched for an electronic watermark matching the setup electronic watermark 142b.

Numeral 144d denotes an “OK” button for confirming the setting on the setting screen 140 and numeral 144e denotes a “CANCEL” button for canceling the setting.

If the user selects a character string 142a out of the listing window 141 on the search target setting screen 140 shown in FIG. 9 and selects the “OK” button 144d, a search target setting section 210 stores the character string 142a in a search target storage section 22 as an electronic watermark 142b, and displays the electronic watermark 142b in the document image 146.

(a) New Registration

If the user selects the “NEW REGISTRATION” button 144a in FIG. 9, a registration window 150 is displayed on a display section, allowing the user to register a new electronic watermark character string.

FIG. 10 shows an example of the registration window. A registration name input field 151a for entering a registration name 152a and a character string input field 151b for entering an electronic watermark character string 152b to set creation of an image log are displayed in the right portion of the registration window 150, and a document image 156 containing the character string 152b entered in the character string input field 151b is displayed in the left portion of the registration window 150. To enter text in the input fields 151a and 151b, if the user operates a mouse of an input section of the client 2 for moving a cursor to the input fields 151a and 151b and operates a keyboard of the input section for entering text and then selects an “OK” button 154a, a character string 152b is newly registered and is displayed on the listing window 141 in FIG. 9.

(b) Edit of Search Target

If the user selects the “EDIT” button 144b in FIG. 9, a similar window is opened. For example, if the user selects “Circular” and then selects the “EDIT” button 144b in FIG. 9, the entry in the registration name input field 151a in FIG. 10 becomes “Circular.”

### (2) Data Analysis

If the user specifies “Circular” as an electronic watermark on the search target setting screen 140 shown in FIG. 9, a data string of the electronic watermark represented in the PDL is described in a PDL description portion 52 as shown in FIG. 11.

A data analysis section 212 analyzes as to whether or not the PDL description portion 52 contains the data string “Circular.” If the PDL description portion 52 contains this data string, an attribute specification section 213 adds an attribute 53 for instructing creation of an image log to a second PJL description portion 51B, and a job file transmission section 214 transmits the job file to a multifunction processing machine 3. The subsequent operation is similar to that in the first exemplary embodiment and therefore will not be described again.

### Third Exemplary Embodiment

Next, a third exemplary embodiment of the invention will be described. While in the first exemplary embodiment, a character string is a search target used in setting an instruction for creating an image log, in the third exemplary embodiment, bit map image information (or text information) such as a logo can be set as a search target. The other portions of the third exemplary embodiment are similar to those of the first exemplary embodiment.

### (Operation of Image Processing System)

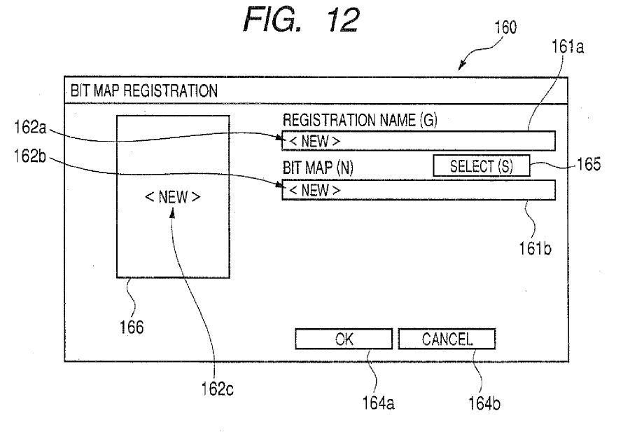

Next, the operation of an image processing system 1 according to the third exemplary embodiment will be described with reference to FIG. 12.

### (1) Setting of Search Target

FIG. 12 shows a registration window 160 in a client 2 according to the third exemplary embodiment of the invention. Provided in the right portion of the registration window 160 are a registration name input field 161a for entering a registration name, a bit map input field 161b for entering, by a character string 162, a bit map image which is the search target and which is represented by arranged dots, and a “SELECT” button 165. A document image 166 having character string 162 represented by a bit map is displayed on the left side of the input fields 161a and 161b. An “OK” button 164a and a “CANCEL” button 164b are provided below the input fields 161a and 161b.

If the user enters a file name containing a directory in a <NEW> part of the bit map input field 161b or selects the “SELECT” button 165 in FIG. 12, a window opens for allowing the user to select a bit map file and the user specifies a bit map out of the window. If the user specifies a bit map and selects the “OK” button 164a, a character string 162a of the bit map is retained in a search target storage section 22 and a bit map 162c set in a document image 166 is displayed.

### (2) Data Analysis

If image data received from application software 20 contains a bit map, a job file generation section 211 describes the bit map in the PDL in a PDL description portion 52. A data analysis section 212 analyzes as to whether or not the PDL description portion 52 contains the data string of the bit map. If the PDL description portion 52 contains the data string, an attribute specification section 213 adds an attribute 53 for instructing creation of an image log to a second PJL description portion 51B, and a job file transmission section 214 transmits the job file to a multifunction processing machine 3. The subsequent operation is similar to that in the first exemplary embodiment and therefore will not be described again.

### Fourth Exemplary Embodiment

Next, a fourth exemplary embodiment of the invention will be described. While in the first exemplary embodiment, a character string is a search target setting an instruction for creating an image log, in the fourth exemplary embodiment, a character string (text information) indicating a time period such as a “retention period,” can be set as a search target. The other portions of the fourth exemplary embodiments are similar to those of the first exemplary embodiment.

### (Operation of Image Processing System)

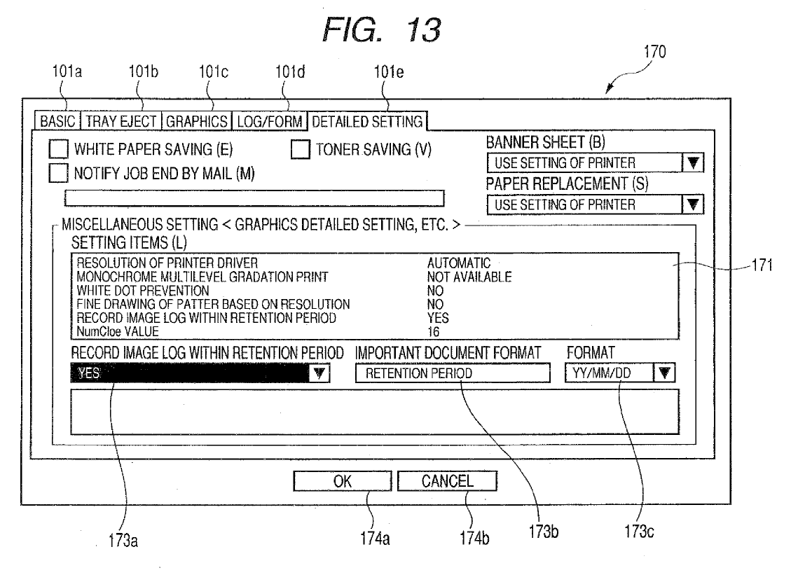

Next, the operation of an image processing system 1 according to the fourth exemplary embodiment will be described with reference to FIG. 13.

### (1) Setting of Search Target

FIG. 13 shows an example of a search target setting screen 170 in a client 2 according to the fourth exemplary embodiment of the invention. The search target setting screen 170 is displayed when the user selects the “DETAILED SETTING” tab 101e on the setting screen 100 in FIG. 3. A listing window 171 for listing detailed setting items is provided in the middle portion of the search target setting screen 170. Provided below the listing window 171 are a selection field 173a for the user to select YES or NO for “RECORD AN IMAGE LOG WITHIN RETENTION PERIOD”, an important document format display field 173b, and a retention period format specification field 173c. An “OK” button 174a and a “CANCEL” button 174b are provided at the bottom of the search target setting screen 170.

In FIG. 13, “YY/MM/DD” is specified in the retention period format specification field 173c. The specification field is a list box, allowing the user to specify a format of YYYY/MM/DD, MM/DD/YY, YYYY.MM.DD, or the like.

If the user sets the selection field 173a of “RECORD AN IMAGE LOG WITHIN RETENTION PERIOD” to YES and specifies the format in the retention period format specification field 173c and then selects the “OK” button 174a, the retention period is stored in a search target storage section 22.

A job file generation section 211 creates a job file from document data received from application software 20 and a data analysis section 212 analyzes as to whether or not a PDL description portion 52 contains a character string indicating the setup retention period. If the PDL description portion 52 contains the character string indicating the “retention period” and the current time is within the retention period, an attribute specification section 213 adds an attribute 53 for instruction creation of an image log to a second PJL description portion 51B, and a job file transmission section 214 transmits the job file to a multifunction processing machine 3. The subsequent operation is similar to that in the first exemplary embodiment and therefore will not be described again.

### Other Embodiments

It is to be understood that the invention is not limited to the specific embodiments thereof and various modifications and changes may be made without departing from the spirit and the scope of the invention. It is also to be understood that the components of the exemplary embodiments can be used in any desired combination without departing from the spirit and the scope of the invention.

For example, the search target may be a copy restraining image (image information or text information). (For example, refer to JP Hei. 11-298717 A.) The “copy restraining image” refers to an image made up of a background pattern not reproduced at the copying time and a hidden pattern reproduced at the copying time. The background pattern includes a dot-like or diagonally-shaped pattern. The hidden pattern includes not only a character string of “for internal use only,” “copy prohibited,” document data creator, etc., but also a symbol, a pattern, etc. Also in this case, PDL is analyzed, whereby whether or not a copy restraining image is contained can be analyzed and if a copy restraining image is contained, an attribute for instruction creation of an image log can be added.

In the exemplary embodiments described above, the image log file is retained in the log server, but may be retained in a multifunction processing machine or external storage without being retained in the log server. The job log and the image log may be retained in different units (apparatus). Although the image log file is generated as a file made up of a job log and an image log, an image log file of a retained image file and a jog log file may be generated independently as they are associated with each other, and may be transmitted separately to the log server.

The programs used in the exemplary embodiments may be read into the apparatus from a record medium such as a CD-ROM or may be downloaded into the apparatus from a server, etc., connected to a network such as the Internet.

In the exemplary embodiments described above, when search target information is contained in image processing data in an interpretable format (for example, PDL description section) when image processing of document data is performed, a creation command of an image of an execution history is given, but when search target information is contained in document data, a creation command of an image of an execution history may be given.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for creating a job, the process comprising:
accepting document data created by application software;
converting the document data into image processing data in a format which is interpretable when image processing is executed for the document data;
determining as to whether or not at least one of the document data and the image processing data contains predetermined information; and
when it is determined that the at least one of the document data and the image processing data contains the predetermined information, outputting a job indicating (i) executing the image processing for the image processing data and (ii) creating an image of an execution history of the image processing.

2. The medium according to claim 1, wherein the process further comprises:
allowing a user to set the predetermined information.

3. The medium according to claim 1, wherein the format of the image processing data is a printer description language.

4. The medium according to claim 1, wherein the image processing for the image processing data comprises printing the image processing data.

5. The medium according to claim 1, wherein:
the predetermined information includes text information corresponding to a retention period,
the process further comprises when it is determined that the at least one of the document data and the image processing data includes the text information, determining as to whether or not a present time is within a period indicated by the text information, and
when it is determined that the at least one of the document data and the image processing data includes the text information and that the present time is within the period indicated by the text information, the outputting outputs the job indicating (i) executing the image processing for the image processing data and (ii) creating the image of the execution history of the image processing.

6. The medium according to claim 1, further comprising:
when it is determined that none of the document data and the image processing data contains the predetermined information, outputting a job (i) indicating execution of the image processing for the image processing data and (ii) including a command for prohibiting creation of an image of an execution history of the image processing.

7. An instruction apparatus comprising:
an accepting unit that accepts document data created by application software;
a converting unit that converts the document data into image processing data in a format which is interpretable when image processing is executed for the document data;
a determining unit that determines as to whether or not at least one of the document data and the image processing data contains predetermined information; and
an outputting unit that outputs a job indicating (i) executing the image processing for the image processing data and (ii) creating an image of an execution history of the image processing, when the determining unit determines that the at least one of the document data and the image processing data contains the predetermined information.

8. The instruction apparatus comprising according to claim 7, wherein:
when the determining unit determines that none of the document data and the image processing data contains the predetermined information, the outputting unit outputs a job (i) indicating execution of the image processing for the image processing data and (ii) including a command for prohibiting creation of an image of an execution history of the image processing.

9. An image processing system comprising:
an instruction apparatus comprising:
an accepting unit that accepts document data created by application software;
a converting unit that converts the document data into image processing data in a format which is interpretable when image processing is executed for the document data;
a determining unit that determines as to whether or not at least one of the document data and the image processing data contains predetermined information; and
an outputting unit that outputs a job indicating (i) executing the image processing for the image processing data and (ii) creating an image of an execution history of the image processing, when the determining unit determines that the at least one of the document data and the image processing data contains the predetermined information; and
a processing apparatus comprising:
a creating unit that executes the image processing for the image processing data and creates the image of the execution history of the image processing before, during or after the executing of the image processing, when the outputting unit of the instruction apparatus outputs the job indicating (i) executing the image processing for the image processing data and (ii) creating the image of the execution history of the image processing.

10. The system according to claim 9, further comprising:
a management apparatus, wherein:
the processing apparatus further comprises:
a transfer unit that transfers the image of the execution history created by the creating unit, and
the management apparatus manages the image of the execution history transferred from the transfer unit, together with identification information of the transferred image.

11. An image processing method comprising:
accepting document data created by application software;
converting the document data into image processing data in a format which is interpretable when image processing is executed for the document data;
determining as to whether or not at least one of the document data and the image processing data contains predetermined information; and
when it is determined that the at least one of the document data and the image processing data contains the predetermined information, outputting a job indicating (i) executing the image processing for the image processing data and (ii) creating an image of an execution history of the image processing.

12. The image processing method according to claim 11, further comprising:
when it is determined that none of the document data and the image processing data contains the predetermined information, outputting a job (i) indicating execution of the image processing for the image processing data and (ii) including a command for prohibiting creation of an image of an execution history of the image processing.

13. The image processing method according to claim 11, further comprising:
when the job indicating (i) executing the image processing for the image processing data and (ii) creating the image of the execution history of the image processing are output, executing the image processing for the image processing data and creating the image of the execution history of the image processing before, during or after the executing of the image processing.

14. A computer data signal embodied in a carrier wave for enabling a computer to perform a process for a process for creating a job, the process comprising:
accepting document data created by application software;
converting the document data into image processing data in a format which is interpretable when image processing is executed for the document data;
determining as to whether or not at least one of the document data and the image processing data contains predetermined information; and
when it is determined that the at least one of the document data and the image processing data contains the predetermined information, outputting a job indicating (i) executing the image processing for the image processing data and (ii) creating an image of an execution history of the image processing.

15. The computer data signal according to claim 14, wherein the process further comprises:
when it is determined that none of the document data and the image processing data contains the predetermined information, outputting a job (i) indicating execution of the image processing for the image processing data and (ii) including a command for prohibiting creation of an image of an execution history of the image processing.
